(19) United States
(12) Patent Application Publication
(10) Pub. No.: US 2025/0086811 A1
(43) Pub. Date: Mar. 13, 2025

(54) MULTI-CAMERA OBJECT TRACKING SYSTEM AND A METHOD OF OPERATING A MULTI-CAMERA OBJECT TRACKING SYSTEM

(71) Applicant: Hendricks Corp. Pte. Ltd., Singapore (SG)

(72) Inventors: Souhail Meftah, Singapore (SG); Ricky Sanjaya, Singapore (SG)

(73) Assignee: Hendricks Corp. Pte. Ltd., Singapore (SG)

(21) Appl. No.: 18/830,172

(22) Filed: Sep. 10, 2024

(30) Foreign Application Priority Data
Sep. 11, 2023 (SG) 10202302532S

(51) Int. Cl. G06T 7/292; G06T 7/70; G06V 10/74

(52) U.S. Cl. CPC G06T 7/292; G06T 7/70; G06V 10/761; G06V 2201/07

(57) ABSTRACT

An aspect of the present disclosure provides a multi-camera object tracking system. The system includes at least one processor; and at least one memory including computer program code. The at least one processor, at least one memory and the computer program code are configured to allow the system to receive an identifier and tracking information associated with each detected object within an overlapping portion of a first video stream from a first camera and a second video stream from a second camera, the overlapping portion associated with partially overlapping fields of view of the first and second cameras, determine positional information of each detected object relative to a common coordinate system using the tracking information and a homography matrix associated with the partially overlapping fields of view of the first and second cameras, match one detected object in the first video stream with another detected object in the second video stream, based on a criterion of minimum distance between the detected objects, using the positional information of each detected object, associate the identifiers of the matched objects, and record the associated identifiers in a correspondence table for object tracking analysis.

### TECHNICAL FIELD

The present invention generally relates to a multi-camera object tracking system and a method of operating a multi-camera object tracking system.

### BACKGROUND ART

Multi-camera object tracking systems are widely used in various applications, including surveillance, retail and traffic monitoring. These systems rely on multiple cameras to monitor and track objects as they move through different fields of view. The ability to accurately track objects across different camera fields of view is critical for ensuring consistent and reliable monitoring.

However, existing multi-camera object tracking systems often encounter difficulties in maintaining accurate tracking, particularly in complex environments with occlusions, lighting variations, and overlapping fields of view. To overcome these challenges, it has become a common practice to supplement camera data with additional technologies such as Wi-Fi, Bluetooth, and other sensor networks. These supplementary technologies are used to provide additional positional data or environmental context that the cameras alone may not capture.

While these supplementary technologies can improve tracking accuracy, they also introduce significant drawbacks. The need for additional hardware, such as Wi-Fi modules, Bluetooth beacons, and various sensors, often increases the overall cost of the system. Furthermore, integrating these technologies with the camera system adds complexity to the installation and maintenance processes. The reliance on multiple technologies can also lead to issues with data synchronisation and increased power consumption, further complicating system operation.

In addition to these concerns, the incorporation of supplementary technologies may introduce potential network vulnerabilities. Wi-Fi and Bluetooth components can be susceptible to security threats such as unauthorised access, signal interception, and interference, which can compromise the integrity and reliability of the tracking system. The increased connectivity and reliance on external networks can also create additional points of failure and potential security risks, making the system more vulnerable to cyber-attacks and data breaches. Consequently, these vulnerabilities can undermine the effectiveness of the tracking system and necessitate additional measures to secure the network, further increasing the overall cost and complexity of the system.

Accordingly, what is needed is a multi-camera object tracking system and a method of operating a multi-camera object tracking system that seek to address some of the above problems. Furthermore, other desirable features and characteristics will become apparent from the subsequent detailed description and the appended claims, taken in conjunction with the accompanying drawings and this background of the disclosure.

### SUMMARY OF INVENTION

An aspect of the present disclosure provides a multi-camera object tracking system. The system includes at least one processor; and at least one memory including computer program code. The at least one processor, at least one memory and the computer program code are configured to allow the system to receive an identifier and tracking information associated with each detected object within an overlapping portion of a first video stream from a first camera and a second video stream from a second camera, the overlapping portion associated with partially overlapping fields of view of the first and second cameras, determine positional information of each detected object relative to a common coordinate system using the tracking information and a homography matrix associated with the partially overlapping fields of view of the first and second cameras, match one detected object in the first video stream with another detected object in the second video stream, based on a criterion of minimum distance between the detected objects, using the positional information of each detected object, associate the identifiers of the matched objects, and record the associated identifiers in a correspondence table for object tracking analysis.

In an embodiment of the present disclosure, in receiving the identifier and tracking information associated with each detected object within the overlapping portion of the first video stream from the first camera and the second video stream from the second camera, the system is configured to receive the first video stream from the first camera and the second video stream from the second camera, detect objects in the first and the second video streams within the overlapping portion of the first and the second video streams, determine tracking information associated with each detected object; and record the identifier and the tracking information associated with each detected object.

The tracking information can include a detection box and, in determining the tracking information associated with each detected object, the system can be configured to map an element of the detection box of each detected object within the overlapping portion in the first and second video streams to the common coordinate system using the homography matrix associated with the partially overlapping fields of view of the first and second cameras.

In an embodiment of the present disclosure, in matching the one detected object in the first video stream with the another detected object in the second video stream based on the minimum distance therebetween using the positional information of each detected object, the system is configured to calculate, for each detected object in the first video stream, a distance between the element and a corresponding element of a detected object in the second video stream, determine a pair including an element in the first video stream and a corresponding element in the second video stream with a minimum distance therebetween, and match the detected object in the first video stream associated with the element with the detected object in the second video stream associated with the corresponding element.

The system is also configured to associate the matched objects with a unique global identifier and record the global identifier in the correspondence table for object tracking analysis.

In an embodiment of the present disclosure, in associating the matched objects with the unique global identifier, the system is configured to determine if any of the identifiers of the matched objects correspond to an existing global identifier; and in response to a positive determination that at least one of the identifiers of the matched objects correspond to an existing unique identifier, verify that the matched objects in the first and second video stream associated with the existing global identifier meet the criterion of minimum distance between the detected objects using the positional information of each detected object.

The system is also configured to, in response to a positive determination that the matched objects in the first and second video stream do not meet the criterion of minimum distance, re-match one detected object in the first video stream with another detected object in the second video stream based on the criterion of minimum distance between the detected objects, using the positional information of each detected object, associate the identifiers of the matched objects, and update the global identifier in the correspondence table for object tracking analysis.

An aspect of the present disclosure provides a method of operating a multi-camera object tracking system. The method includes receiving, by a processing device, an identifier and tracking information associated with each detected object within an overlapping portion of a first video stream from a first camera and a second video stream from a second camera, the overlapping portion associated with partially overlapping fields of view of the first and second cameras, determining, using the processing device, positional information of each detected object relative to a common coordinate system using the tracking information and a homography matrix associated with the partially overlapping fields of view of the first and second cameras, matching, using the processing device, one detected object in the first video stream with another detected object in the second video stream, the matching based on a criterion of minimum distance between the detected objects, using the positional information of each detected object, associating, using the processing device, the identifiers of the matched objects, and recording, using the processing device, the associated identifiers in a correspondence table for object tracking analysis.

In an embodiment, the step of receiving the identifier and the tracking information associated with each detected object within the overlapping portion can include receiving, by the processing device, the first video stream from the first camera and the second video stream from the second camera, detecting, using the processing device, objects in the first and the second video streams within the overlapping portion of the first and the second video streams, determining, using the processing device, tracking information associated with each detected object, and recording, using the processing device, the identifier and the tracking information associated with each detected object.

In an embodiment, the tracking information can include a detection box and the step of determining the tracking information associated with each detected object can include mapping, using the processing device, an element of the detection box of each detected object within the overlapping portion in the first and second video streams to the common coordinate system using the homography matrix associated with the partially overlapping fields of view of the first and second cameras.

In an embodiment, the step of matching the one detected object in the first video stream with the another detected object in the second video stream based on the minimum distance therebetween using the positional information of each detected object can include calculating, for each detected object in the first video stream, a distance between the element and a corresponding element of a detected object in the second video stream using the processing device, determining, using the processing device, a pair including an element in the first video stream and a corresponding element in the second video stream with a minimum distance therebetween, and matching the detected object in the first video stream associated with the element with the detected object in the second video stream associated with the corresponding element.

The method can also include the steps of associating, using the processing device, the matched objects with a unique global identifier, and recording, using the processing device, the global identifier in the correspondence table for object tracking analysis.

In an embodiment, the step of associating the matched objects with the unique global identifier can include determining, using the processing device, if any of the identifiers of the matched objects correspond to an existing global identifier; and in response to a positive determination that at least one of the identifiers of the matched objects correspond to an existing unique identifier, verifying, using the processing device, that the matched objects in the first and second video stream associated with the existing global identifier meet the criterion of minimum distance between the detected objects using the positional information of each detected object.

The method can also include, in response to a positive determination that the matched objects in the first and second video stream do not meet the criterion of minimum distance, re-matching, using the processing device, one detected object in the first video stream with another detected object in the second video stream based on the criterion of minimum distance between the detected objects, using the positional information of each detected object, associating, using the processing device, the identifiers of the matched objects, and updating, using the processing device, the global identifier in the correspondence table for object tracking analysis.

### BRIEF DESCRIPTION OF DRAWINGS

Embodiments of the invention will be better understood and readily apparent to one of ordinary skill in the art from the following written description, by way of example only, and in conjunction with the drawings, in which:

FIG. 1 shows a schematic diagram of a multi-camera object tracking system, in accordance with embodiments of the disclosure.

FIG. 2 shows a schematic diagram of an example implementation of the multi-camera object tracking system of FIG. 1, in accordance with embodiments of the disclosure.

FIG. 3 shows a flowchart illustrating a method of tracking an object across multiple cameras, in accordance with embodiments of the disclosure.

FIG. 4 shows a flowchart illustrating a method of operating a multi-camera object tracking system, in accordance with embodiments of the disclosure.

FIG. 5 shows a schematic diagram of a computing device used to realise the system of FIG. 1.

Skilled artisans will appreciate that elements in the figures are illustrated for simplicity and clarity and have not necessarily been depicted to scale. For example, the dimensions of some of the elements in the illustrations, block diagrams or flowcharts may be exaggerated in respect to other elements to help to improve understanding of the present embodiments.

### DESCRIPTION OF EMBODIMENTS

Embodiments of the present invention will be described, by way of example only, with reference to the drawings. Like reference numerals and characters in the drawings refer to like elements or equivalents. The following detailed description is merely exemplary in nature and is not intended to limit the invention or the application and uses of the invention. Furthermore, there is no intention to be bound by any theory presented in the preceding background of the invention or the following detailed description. Herein, a modular fluid processing tank is presented in accordance with present embodiments having the advantages of transportability, modularity and scalability.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “associating”, “calculating”, “comparing”, “determining”, “forwarding”, “generating”, “detecting”, “including”, “inserting”, “modifying”, “receiving”, “replacing”, “retrieving”, “scanning”, “storing”, “transmitting” or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may include a computer or other computing device selectively activated or reconfigured by a computer program stored therein. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on a computer effectively results in an apparatus that implements the steps of the preferred method.

In embodiments of the present invention, use of the term ‘server’ may mean a single computing device or at least a computer network of interconnected computing devices which operate together to perform a particular function. In other words, the server may be contained within a single hardware unit or be distributed among several or many different hardware units.

The term “configured to” is used in the specification in connection with systems, apparatus, and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. For special-purpose logic circuitry to be configured to perform particular operations or actions means that the circuitry has electronic logic that performs the operations or actions.

Embodiments of the present disclosure provide a multi-camera object tracking system and a method of operating a multi-camera object tracking system. In embodiments, the multi-camera object tracking system can include at least one processor; and at least one memory including computer program code. The at least one processor, at least one memory and the computer program code are configured to allow the system to (i) receive an identifier and tracking information associated with each detected object within an overlapping portion of a first video stream from a first camera and a second video stream from a second camera, the overlapping portion associated with partially overlapping fields of view of the first and second cameras, (ii) determine positional information of each detected object relative to a common coordinate system using the tracking information and a homography matrix associated with the partially overlapping fields of view of the first and second cameras, (iii) match one detected object in the first video stream with another detected object in the second video stream, based on a criterion of minimum distance between the detected objects, using the positional information of each detected object, (iv) associate the identifiers of the matched objects, and (v) record the associated identifiers in a correspondence table for object tracking analysis. The object tracking analysis can include video analytics.

In embodiments, the multi-camera object tracking system can also be configured to (i) receive the first video stream from the first camera and the second video stream from the second camera, (ii) detect objects in the first and the second video streams within the overlapping portion of the first and the second video streams, (iii) determine tracking information associated with each detected object, and (iv) associate each detected object with the identifier and the tracking information.

In exemplary embodiments, a video stream can include, but is not limited to, one or more of the following: live video stream data and recorded video data, the live video stream data being video content captured and transmitted in real-time, and the recorded video data being video contact captured and stored for deferred playback or analysis. The video stream can include a digital representation of content captured by one or more image capturing devices and can be stored in the form of sequences of images or image frames. The video stream can also include metadata such as resolution, frame rate, encoding format, duration, and additional details like timestamps, camera settings, and geolocation data. In embodiments of the invention, video stream can include video analytics data, the video analytics data being information derived from the analysis of video data using processes described hereinafter, and can include, but is not limited to patterns, trends, and metrics derived from the video data.

In exemplary embodiments, video analytics can include processing and analysis of the video stream to extract data and information, using algorithms including but not limited to: computer vision algorithms, machine learning algorithms, and artificial intelligence, to detect and track objects, recognise patterns, and detect specific events or behaviours within the video stream. Video analytics can be used for various applications such as security surveillance, retail analytics, traffic monitoring, and behavioural analysis. In exemplary embodiments, the multi-camera object tracking system and the video analytic system can process video streams in real-time or from recorded footage to provide information based on the analysis of visual data which users can use for insights and/or alerts.

In exemplary embodiments, the multi-camera object tracking system may be implemented in a retail environment to map a customer's journey within a retail store and facilitate real-time tracking and analysis of the customer. Advantageously, customer preferences, movement and interactions within the store can be tracked, thereby providing insights that may be used to optimise store layout, identify shopping patterns, monitor customer movement, improve customer experience and inventory management, and enhance operational efficiency. For example, the multi-camera object tracking system can be used to obtain statistical and demographic data concerning customers entering and exiting the store, the duration spent at specific display areas within the store, and behavioural analysis of visitor interactions. More advantageously, the multi-camera object tracking system in accordance with embodiments of the disclosure can capture the customer at any point within the store and consistently recognise the same customer across multiple camera views without the need for auxiliary technologies such as Wi-Fi, Bluetooth, or other external sensors, which can increase system complexity.

The multi-camera object tracking system may also be used in surveillance settings. The multi-camera object tracking system can enhance security by enabling continuous monitoring and tracking of individuals or objects across multiple locations within a facility. The multi-camera object tracking system can use a network of cameras with partially overlapping fields of view each capturing video feeds that can be processed and analysed in real-time. By integrating and correlating data from different camera feeds, the system can accurately track the movement of individuals or objects as they transition between the fields of view of different cameras. This continuous tracking capability can improve the detection of suspicious behaviour or security threats, and can allow for effective responses to potential incidents.

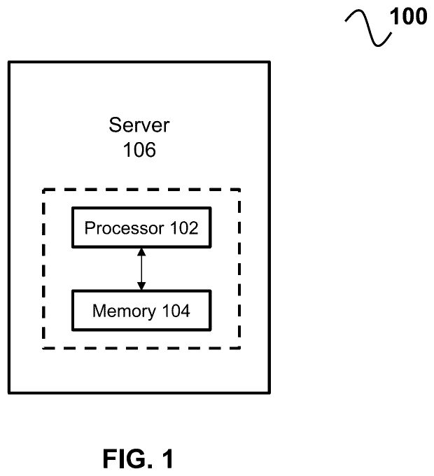

FIG. 1 shows a schematic diagram of a multi-camera object tracking system 100, in accordance with embodiments of the disclosure. In exemplary embodiments, the system 100 can include at least one processor 102 and at least one memory 104 including computer program code. The at least one processor 102 and the at least one memory 104 can be housed in a server 106. The at least one processor 102, at least one memory 104 and the computer program code are configured to allow the system 100 to (i) receive an identifier and tracking information associated with each detected object within an overlapping portion of a first video stream from a first camera and a second video stream from a second camera, the overlapping portion associated with partially overlapping fields of view of the first and second cameras, (ii) determine positional information of each detected object relative to a common coordinate system using the tracking information and a homography matrix associated with the partially overlapping fields of view of the first and second cameras, (iii) match one detected object in the first video stream with another detected object in the second video stream, based on a criterion of minimum distance between the detected objects, using the positional information of each detected object, (iv) associate the identifiers of the matched objects, and (v) record the associated identifiers in a correspondence table for object tracking analysis.

In example embodiments, the system 100 can also be configured to (i) receive the first video stream from the first camera and the second video stream from the second camera, (ii) detect objects in the first and the second video streams within the overlapping portion of the first and the second video streams, (iii) determine tracking information associated with each detected object, and (iv) associate each detected object with the identifier and the tracking information.

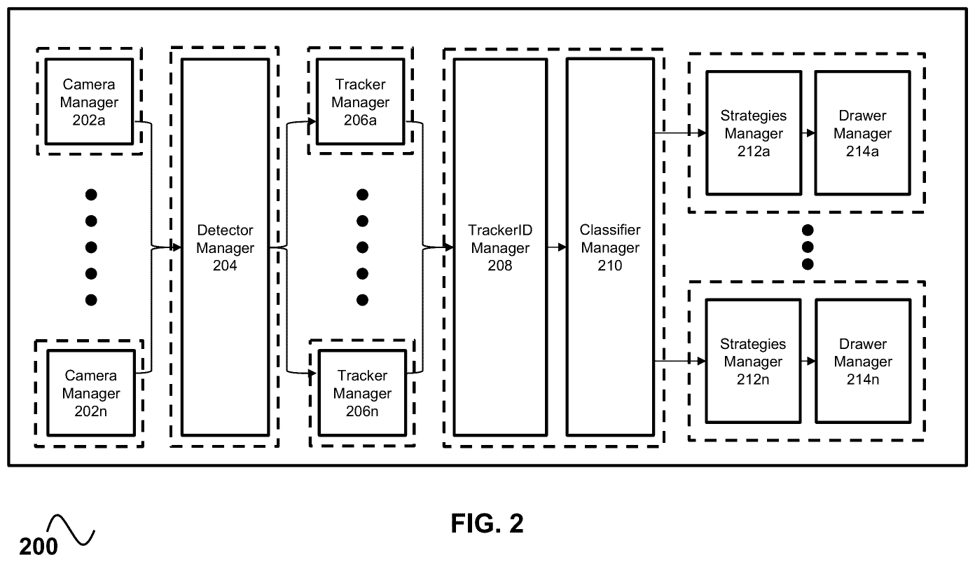

FIG. 2 shows a schematic diagram of an example implementation of the multi-camera object tracking system 100 of FIG. 1, in accordance with embodiments of the disclosure. The multi-camera object tracking system 100 can be configured to run a multi-camera object tracking application 200 which includes a set of instructions in machine-readable format that is executable by the object tracking system 100 to perform the various functions described herein. In exemplary embodiments, the object tracking system 100 can be configured to detect and track objects across at least two image capturing devices (hereinafter interchangeably referred to as cameras), the cameras having partially overlapping fields of view (FOVs).

The multi-camera object tracking application 200 in accordance with embodiments of the disclosure can include one or more managers, each being a subroutine or program configured to perform one or more specific functions within the application. Each of the one or more managers can include instructions in machine-readable format that is executable by the multi-camera object tracking application 200 to perform the various functions described in more detail below. In an example embodiment as shown in FIG. 2, the multi-camera object tracking application 200 can include, but is not limited to, camera managers 202a . . . 202n, a detector manager 204, tracker managers 206a . . . 206n, a trackerid manager 208 and a classifier manager 210. The multi-camera object tracking system 200 can also include strategies managers 212a . . . 212n and drawer managers 214a . . . 214n.

In an embodiment of the present disclosure, each of the camera managers 202a . . . 202n can cause the multi-camera object tracking system 100 to receive a video stream from a respective video source (e.g. a camera or a server storing a video stream), process the video stream and transmit image frames of the video stream to the detector manager 204. In embodiments, the plurality of camera managers 202a . . . 202n can also cause the multi-camera object tracking system 100 to control and coordinate each of the multiple cameras within a networked environment. The camera managers 202a . . . 202n can also manage camera settings (e.g. adjust resolution or frame rate), initiate or terminate video streams, and allocate processing resources to ensure efficient operation (e.g. to maximize hardware utilisation or minimise delays). The plurality of camera managers 202a . . . 202n can also facilitate the synchronisation of video feeds to enable accurate object tracking and identification across different cameras. In embodiments, the management of camera settings can include adjusting camera parameters such as focus, zoom, and exposure, either automatically based on detected conditions or manually through user input. While the foregoing description refers to each of the plurality of camera managers 202a . . . 202n managing a single video stream, it is understood that this function can alternatively be performed by a single camera manager.

The detector manager 204 can cause the multi-camera object tracking system 100 to receive image frames from one or more camera managers and to perform object detection using an object detection model (e.g. with You Only Look Once version 7 (YOLOv7)). The detector manager 204 can associate each detected object with a corresponding detection box. The detector manager 204 can also cause the multi-camera object tracking system 100 to transmit the image frames, along with the detection box information, to the plurality of tracker managers 206a . . . 206n. The detector manager 204 can be configured to process the frames sequentially, in parallel, or a combination of both, depending on the configuration of the detection model.

In other words, the camera managers 202a . . . 202n and the detector manager 204 can cause the multi-camera object tracking system 100 to at least (i) receive the first video stream from the first camera and the second video stream from the second camera, the first and second cameras having partially overlapping fields of view, (ii) detect objects in the first and the second video streams within the overlapping portion of the first and the second video streams, the overlapping portion associated with the partially overlapping fields of view of the first and second cameras, and (iii) associate each detected object with a corresponding detection box.

In an embodiment of the present disclosure, each of the plurality of tracker managers 206a . . . 206n is associated with a respective video source and can cause the multi-camera object tracking system 100 to receive the image frames along with the detection box information from the detector manager 204. Each of the plurality of tracker managers 206a . . . 206n can process the image frames along with the detection box information associated with the respective video source to determine which detection boxes in the current frame correspond to those in the previous frame, and can track each detected object by assigning a unique identifier for each detected object (referred to hereinafter interchangeably as an object identifier). The data generated by each tracker manager 206a . . . 206n, which processes image frames and detection box information from respective video sources to determine the correspondence of detection boxes across consecutive frames is referred to as tracking information. The tracking information, along with the unique identifier (ID) for each detection box, is transmitted to the trackerid manager 208. Exemplary tracking algorithm used can include ByteTrack and DeepSORT. In embodiments of the present disclosure, the tracking information can include data associated with the assignment of a unique identifier to each detected object that enables continuous tracking of the object's movement across frames. While the foregoing description refers to each of the plurality of tracker managers 206a . . . 206n to determine the tracking information associated with each detected object and to associate each detected object with the identifier and the tracking information, it is understood that this function can alternatively be performed by a single tracker manager. In other words, the plurality of tracker managers 206a . . . 206n can cause the multi-camera object tracking system 100 to at least to (i) determine tracking information associated with each detected object and (ii) record the identifier and the tracking information associated with each detected object.

In an embodiment of the present disclosure, the trackerid manager 208 can cause the multi-camera object tracking system 100 to receive the object identifier from the plurality of tracker managers 206a . . . 206n and to synchronise the identifiers across multiple video streams. That is, the trackerid manager 20 can associate an identifier in one frame from one video stream to another identifier in a frame from another video stream to achieve multi-camera tracking. In an embodiment, the multi-camera tracking is achieved by mapping the ground plane between a pair of video sources (e.g., a pair of cameras) via homography to obtain a linear mapping (homography matrix, H]) that maps points on a ground plane of one video source to that of another. Mathematically, given any point pₗ, pᵣ ∈R², we want to find H∈R³×R³ such that c [pᵣ, 1]^{T}=H[pₗ, 1]^{T}, where c∈R is a constant, pₗ, pᵣ are pixel coordinates in the left and right camera frame respectively, and H is a 3 by 3 matrix. Once H is found, a common element (e.g. vertex, or midpoint) of each detection box in an image frame of one video stream can be matched with a corresponding feature in another detection box in an image frame of another video stream based on minimisation of the total distance between the common elements. Once the identifiers are associated/synchronised across multiple video feeds, the associated/synchronised identifiers are transmitted to the classifier manager 210.

In other words, the trackerid manager 208 can cause the multi-camera object tracking system 100 to at least to (i) receive the identifier and tracking information associated with each detected object within the overlapping portion of the first video stream and the second video stream from a second camera, (ii) determine positional information of each detected object relative to a common coordinate system using the tracking information and the homography matrix associated with the partially overlapping fields of view of the first and second cameras; (iii) match one detected object in the first video stream with another detected object in the second video stream, based on a criterion of minimum distance between the detected objects, using the positional information of each detected object; (iv) associate the identifiers of the matched objects, and (iv) record the associated identifiers in a correspondence table for object tracking analysis.

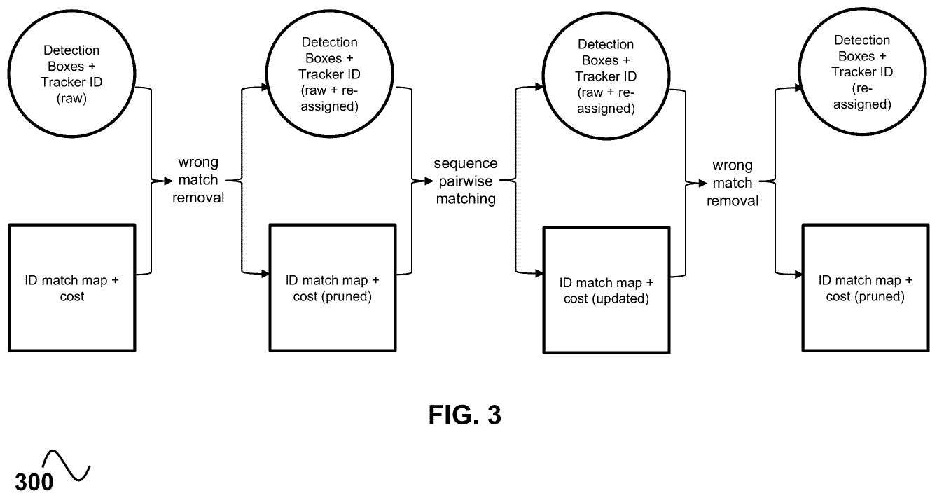

In an embodiment, the tracking information includes the detection box, and the trackerid manager 208 can cause the multi-camera object tracking system 100 to map an element of the detection box of each detected object within the overlapping portion in the first and second video streams to the common coordinate system using the homography matrix associated with the partially overlapping fields of view of the first and second cameras. The trackerid manager 208 can also cause the multi-camera object tracking system 100 to calculate, for each detected object in the first video stream, a distance between the element and a corresponding element of a detected object in the second video stream, determine a pair comprising an element in the first video stream and a corresponding element in the second video stream with a minimum distance therebetween, and match the detected object in the first video stream associated with the element with the detected object in the second video stream associated with the corresponding element. In an embodiment, the trackerid manager 208 can also cause the multi-camera object tracking system 100 to associate the matched objects with a unique global identifier, and record the global identifier in the correspondence table for object tracking analysis. Details are provided in the following description in reference to FIG. 3.

In an embodiment of the present disclosure, the classifier manager 210 can cause the multi-camera object tracking system 100 to receive the detection box associated with each object from the detector manager 204 and the associated identifiers from the trackerid manager 208. For example, in a retail environment, the classifier manager 210 can be configured to classify each object (e.g., as a customer, staff member, or child) if the object has not been previously classified. The classification can use one or more algorithms including, but not limited to ResNet50, AlexNet and VGGNet. The classification results are then transmitted to downstream components for per-class analytics.

In an embodiment of the present disclosure, in the retail environment, the strategies managers 212a . . . 212n can cause the multi-camera object tracking system 100 to use the detection box location and user-configurable Regions of Interest (ROI) to determine whether a person is dwelling in specific areas of the retail store or entering/exiting the premises. In one example embodiment, the strategies managers 212a . . . 212n can use one or more of the following approaches (i) “Origin Destination”, which uses a pair of ROIs to track movement between them for counting retail store entries and exits, and (ii) “Dwelling”, which monitors multiple ROIs to assess if and for how long a person lingers in each ROI. The gathered data can then be used to generate a heatmap representing the customer's journey throughout the store. In embodiments, the “Origin Destination” can be used for counting people coming in/out of the retail store, while the “Dwelling” can be used to register the time spent by a person at various spots across the retail store. This information may then be used to construct a heatmap of the customer's journey throughout the store.

In an embodiment of the present disclosure, the drawer manager 214a . . . 214n can cause the multi-camera object tracking system 100 to receive the video stream, the detection boxes, the identifiers and any ROIs involved in earlier components, and display the received information on the display screen in form of a video.

FIG. 3 shows a flowchart illustrating a method 300 of tracking an object across multiple cameras, in accordance with embodiments of the disclosure. The method 300 can be implemented by the server 106 of system 100, hereinafter interchangeably referred to as a processing device. In an embodiment, the trackerid manager 208 can cause the multi-camera object tracking system 100 to implement the method 300, to track mappings between identifiers (IDs) that is tracked by individual tracker managers 206a . . . 206n (hereinafter interchangeably referred to as raw IDs), to the ‘global’ IDs that will be consistent across all cameras (hereinafter interchangeably referred to as re-assigned IDs). In FIG. 3, data inside circles represent data that is taken in as input, processed, and fed to the subsequent sequential blocks. Data inside boxes represent an internal state that the trackerid manager 208 stores throughout the application's operation. “(Detection Boxes+Tracker ID)” refers to the bounding box and associated IDs from the individual trackers of all cameras. ID match map is a dictionary with the key being a raw tracker ID, and the value being its re-assigned ID. Therefore, this match map is referred to as match dictionary or global match dictionary (also referred to interchangeably as a unique global identifier). For each key-value pair, there would be an associated cost, represented by a float number. Details about the operations (i.e., wrong match removal and sequence pairwise matching) are explained below.

In a “wrong match removal” operation, the raw tracker ID and the current ID match map are used as inputs to perform the mapping, to convert the raw tracker ID to reassigned tracker ID. Then, for each camera, the trackerid manager 208 can cause the multi-camera object tracking system 100 to check for duplicates in the re-assigned IDs. If found, the trackerid manager 208 can remove the corresponding mappings in the dictionary and keeps only either the raw tracker ID of that duplicate or keeps one reassigned ID with the lowest mapping cost. Finally, after removing matches (if any) from the match dictionary, the raw tracker ID is re-assigned again, now with the updated match dictionary.

For example, suppose for camera 1, the following raw tracking IDs are received for three visitors->[1001, 2001, 3001]. And suppose for this camera, the following match dictionary is as follows->{2001:1001, 3001:5000}. Therefore, after reassignment, it will result in the following IDs->[1001, 1001, 5000]. In the wrong match removal module, it will understand that there a clash in the assigned identities to the visitors and remove the match {2001:1001}, because the raw tracker ID, i.e. 1001, is present in the raw tracking IDs received. Therefore, the final reassigned IDs from this process will be [1001, 2001, 5000]

In another example, suppose now for camera 1, the following raw tracking IDs are received->[2001, 5001, 8001] and the following match dictionary is as follows for cam1 {2001:1001, 5001:1001, 8001:1001}, with the corresponding costs of 10.0, 11.0, 8.8 respectively. Here, the final reassigned IDs would be [2001, 5001, 1001] as only the {8001:1001} match is retained.

In a “sequence pairwise matching” operation, homography matrices are first configured for a number of camera pairs that have overlapping field of views (FOV areas), to provide a linear mapping from one camera's ground plane to the other. Furthermore, each pair is also associated with a region of interest (ROI) (one on each camera in the pair) which limits the area where boxes and IDs are matched. In sequence pairwise matching, the re-assigned IDs of all cameras are taken in after removal of wrong matches. Then, for each camera pair defined in the configurations, the following 5-step operation is performed. (Note that in the following examples, the number at the end of every ID denotes the index of that camera. e.g., ID 2001 means it's from camera 1)

Step 1: Filter: For each camera in the pair, all the boxes (and their corresponding reassigned IDs) that are not within the defined ROI in the configuration are removed.

Step 2: Transform: Since homography is a directional mapping (i.e., a matrix that is valid for cam A to B is not valid for cam B to A), the pair configuration also denotes from which camera to which camera in the pair is the homography matrix intended. This information and the homography matrix itself may be used to transfer an element of a detection box (e.g. the centre-bottom point) of each box that is within the ROI of one camera, to the other camera. The camera where the points are mapped from is referred to as the ‘left’ camera, and the camera where the points are mapped to as the ‘right’ camera.

Step 3: Matching: After transferring points in step 2, matching is performed by mapping each element transferred from the left camera to the closest bounding box inside the ROI of the right camera. The representative point used for the bounding box in the right camera is consistently the center-bottom point, and the distance metric being used is pixel Euclidean distance. Note that the total cost of the matching is considered instead of matching each point one by one to ensure that each transferred point can only match to one bounding box. Therefore, the problem advantageously reduces to a linear assignment problem. These matchings therefore produce ID matches, i.e., the ID from each transferred point from the left camera, is matched to the ID of the bounding box that this point matched to. Therefore, after this step, a dictionary of matches is obtained (this is referred to as the temporary match dictionary), and the associated cost of each match (i.e., the Euclidean distance above) is also obtained.

Step 4: Global Update: The dictionary of matches and its associated cost obtained in iii) is used and the match dictionary of all affected cameras is updated. For each entry in the obtained temporary match dictionary, its corresponding entry in the global match dictionary (also referred to interchangeably as the unique global identifier) is updated only if the match obtained in the temporary match dictionary has lower cost than what is already being kept track of.

In one example, suppose for camera 1, the global match dictionary {2001:1001} with a cost 10.0 is available. Then in the temporary match dictionary, {2001:8000} is obtained with a cost of 8.8. Therefore, the update is performed, i.e., the global match dictionary now becomes {2001:8000}. If the entry does not exist yet in the global dictionary, then that entry is created.

In another example, suppose now {2001:8000} is obtained and 2001 is not a key in the global dictionary of camera 1; therefore the above match is updated into the global dictionary of camera 1.

Step 5: Refine: After updating the global match dictionary, the global match dictionary is refined to remove ‘chains of ID match’.

In one example, suppose for suppose for camera 1, its global match dictionary is {3001:2001}. Then in the temporary match dictionary, {2001:1000} is obtained. Therefore, refining the global match dictionary would yield {3001:1000}.

After these 5 steps, the match dictionary will thus have been updated. Therefore, the ID reassignment is repeated, and above 5 steps for the next camera pair in the configuration is performed.

In other words, the trackerid manager 208 can cause the multi-camera object tracking system 100 to determine if any of the identifiers of the matched objects correspond to an existing global identifier; and in response to a positive determination that at least one of the identifiers of the matched objects correspond to an existing unique identifier, verify that the matched objects in the first and second video stream associated with the existing global identifier meet the criterion of minimum distance between the detected objects using the positional information of each detected object. The trackerid manager 208 can also cause the multi-camera object tracking system 100 to, in response to a positive determination that the matched objects in the first and second video stream do not meet the criterion of minimum distance, re-match one detected object in the first video stream with another detected object in the second video stream based on the criterion of minimum distance between the detected objects, using the positional information of each detected object, associate the identifiers of the matched objects, and update the global identifier in the correspondence table for object tracking analysis.

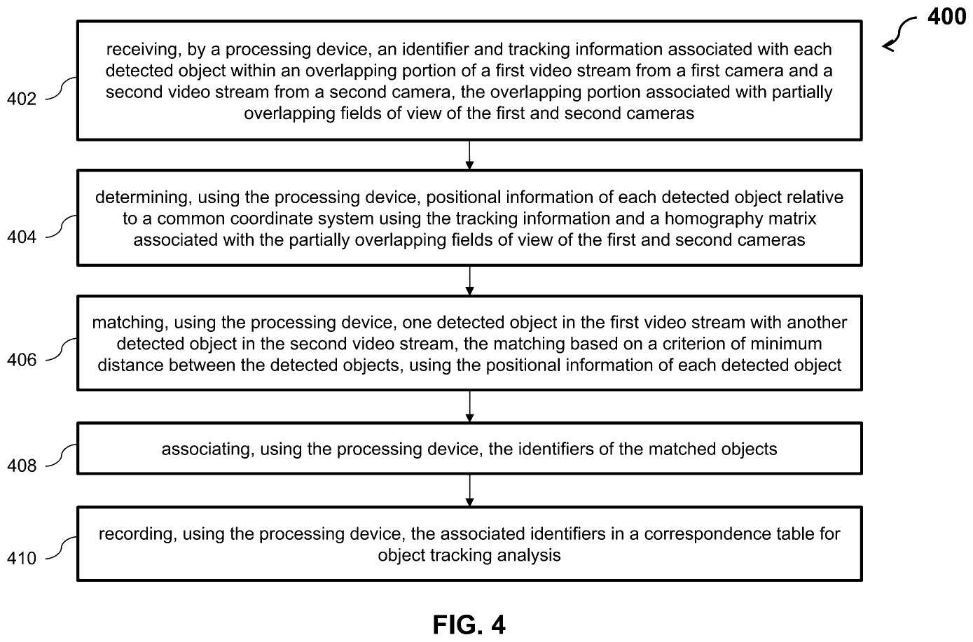

FIG. 4 shows a flowchart illustrating a method 400 of operating a multi-camera object tracking system, in accordance with embodiments of the disclosure. The method 400 can be implemented by the server 106 of system 100, hereinafter interchangeably referred to as a processing device. The method 400 broadly includes step 402 of receiving, by a processing device, an identifier and tracking information associated with each detected object within an overlapping portion of a first video stream from a first camera and a second video stream from a second camera, the overlapping portion associated with partially overlapping fields of view of the first and second cameras, step 404 of determining, using the processing device, positional information of each detected object relative to a common coordinate system using the tracking information and a homography matrix associated with the partially overlapping fields of view of the first and second cameras, step 406 of matching, using the processing device, one detected object in the first video stream with another detected object in the second video stream, the matching based on a criterion of minimum distance between the detected objects, using the positional information of each detected object, step 408 of associating, using the processing device, the identifiers of the matched objects and step 410 of recording, using the processing device, the associated identifiers in a correspondence table for object tracking analysis.

In an embodiment of the present disclosure, the multi-camera object tracking system can map a customer's journey within a store, and address challenges such as capturing customer movements and recognising the same individual across multiple cameras. The technical challenges addressed include: (a) Person Detection: identifying and localising individuals within an image frame by placing a detection box around them, (b) Tracking: once a person is detected, recognising and tracking that individual across subsequent frames from the same camera, (c) Classification: distinguishing whether a detected person is a customer, store staff, security personnel, or another category, (d) Multi-Camera Tracking: determining whether the same person detected in one camera's frame corresponds to the person detected in another camera's frame, whether appearing simultaneously or at different times and (e) Analytics: processing the tracked and classified data into information, such as counting entries/exits, measuring dwell times, and generating real-time heatmaps, dashboards, and alerts. Embodiments of the present disclosure integrate the aforementioned functions into a single, cost-effective system that uses existing security cameras, eliminating the need for additional hardware and supplementary technologies such as Wi-Fi, Bluetooth, or sensors, which can increase costs and reduce accuracy.

Furthermore, in embodiments of the present disclosure, enhancements can include one or more of the following: (a) Detection: fine-tuning pre-trained YOLO v7 weights for the specific environment e.g., retail environment to achieve better detection accuracy (i.e. increased performance and reduced detection drops) compared with standard models, (b) Tracking: introducing new configuration parameters to user interface of the multi-camera object tracking application to give users greater control over tracking algorithms, and reducing detection box transfer issues and ID drops (c) Classification: implementing a ResNet50-based model with a custom softmax layer for multi-class classification, fine-tuned using proprietary datasets to greater accuracy compared to standard ResNet50, (d) Multi-Camera Tracking: employing a pairwise ground plane mapping approach as described above to transfer detected detection box elements between cameras, with an efficient algorithm for matching corresponding elements to advantageously alleviate use of neural networks, enabling fast and efficient performance. Accordingly, embodiments of the disclosure can deliver superior accuracy and cost efficiency, outperforming competitors that rely on motion sensors and other technologies. The system leverages existing security cameras, offering clients a high-performance, low-cost solution for customer journey mapping.

Additionally, as shown in FIG. 1 and described in the aforementioned paragraphs, the multi-camera object tracking system in accordance with embodiments of the present disclosure provides modular components, enabling an end-to-end solution that can be tailored to meet specific user requirements. This modularity also ensures that the system can be easily adapted for other use cases with minimal modifications. Particularly,

each component (depicted by the dashed boxes) can be re-arranged in any configuration as required. The number of boxes and their connections are fully customisable, enabling a ‘plug and play’ solution. For other use cases, sequential components may be added, removed, or re-arranged to suit specific needs. Additionally, the manager/module arrangement (depicted by the solid lined boxes) is equally flexible, allowing for the insertion of multiple managers into each sequential block as needed. New managers can be created by adhering to defined coding conventions and integrated into sequential components to introduce new functionalities, such as face recognition algorithms. This modular approach reduces the time required to customise the application for new use cases or user requirements, making it efficient, sustainable, and scalable.

Embodiments of the present disclosure can generate information and outputs for object tracking analysis and video analytics. For applications where the system is used in real-time, processing at a minimum frame rate to avoid noticeable lags or frame drops is required. In an embodiment, the sequential components can be connected in a simple, sequential manner to meet responsiveness requirements. To meet real-time requirements of 10-15 frames per second (fps) while incorporating machine learning models for detectors and classifiers, a parallel-processing mechanism is implemented, allowing data to flow in the sequence described in the diagram (i.e., from the camera managers 202a . . . 202n, to the detector manager 204, the tracker managers 206a . . . 206n, the trackerid manager 208, the classifier manager 210, the strategies managers 212a . . . 212n and finally to drawer managers 214a . . . 214n), while enabling simultaneous processing across all sequential block. Although sequential blocks process different frame instances, they can operate concurrently, enhancing overall speed. Further optimisations include improving data transfer speed between sequential blocks using multi-threading and shared memory, leveraging hybrid GPU and CPU processing, and other optimisation techniques to ensure efficient real-time performance.

Embodiments of the disclosure can also include one or more of the following features. In an embodiment, object classification can be performed based on appearance or clothing. The camera may be RGB to allow for the distinction of a person's class by capturing full-colour images. Embodiments of the disclosure can also include a security module that can cause the multi-camera object tracking system to detect and blur faces in real time within camera feeds. Access to anonymised data can restricted to authorised personnel, such as the store manager, ensuring that data remains secure, is protected from unauthorised duplication or erasure and to meeting data protection laws in respective jurisdictions. The security module can also safeguards the system against reverse engineering and unauthorised use or distribution. Embodiments of the disclosure can include customized application-specific integrated circuits (ASICs) to optimise performance for edge computing. Customized ASICs can enhance real-time analysis and reduce latency in cameras, while also offering long-term cost savings through reduced power consumption and lower hardware maintenance requirements. The ASICs may be housed in a compact camera module with necessary I/O ports to save space.

Embodiments of the disclosure can include internet of things (IoT) integration: Embodiments of the disclosure can integrate IoT sensors to complement video analytics, enabling functions such as heatmapping customer journeys, detecting spillage and littering, and tracking customer interactions with staff or merchandise. The software interface can support integration with numerous IoT sensors, facilitating continuous data streaming to a database for predictive modelling of footfall, inventory management, and the assessment of sales and marketing campaigns. This integration can enhance the system's performance and accuracy. Embodiments of the disclosure can include intelligent automated assistance functionality, wherein the system's multi-camera tracking capability can allow users to identify customers who repeatedly return to the same shelf or product within a short-predefined time span. In such cases, Bluetooth geolocation technology may be used to send context-aware, personalised offers and discounts to the customer's mobile device via push notifications. Customers can also request staff assistance through a mobile app, with staff being able to locate them precisely within the store. The intelligent automated assistance functionality can also enhance the customer's shopping experience in the store without having to wait for or talk to store assistants, and provide a unique and personalised retail experience.

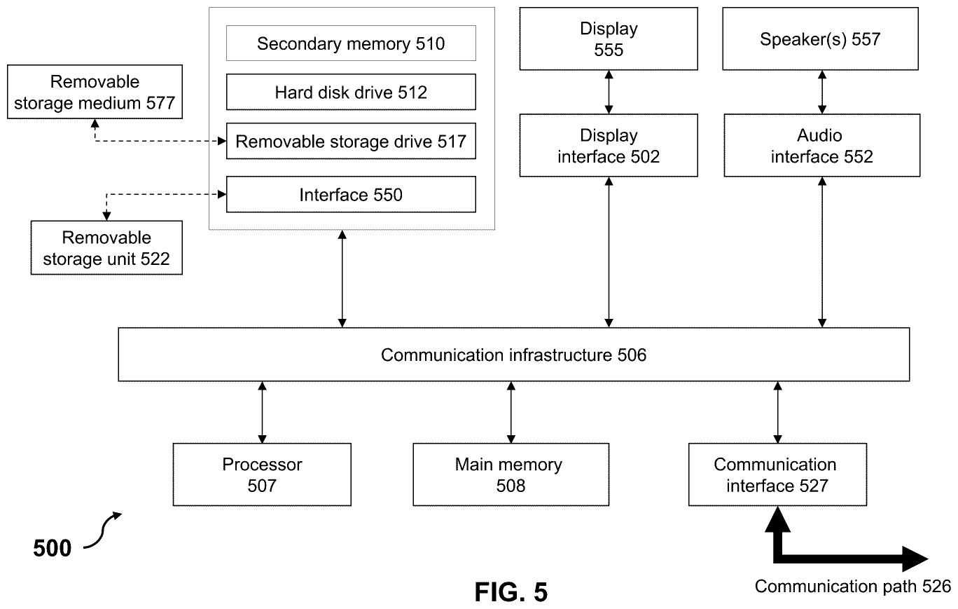

FIG. 5 depicts an exemplary computing device 500, hereinafter interchangeably referred to as a computer system 500, where one or more such computing devices 500 may be used to execute the method 400 of FIG. 4. One or more components of the exemplary computing device 500 can also be used to implement the system 100. The following description of the computing device 500 is provided by way of example only and is not intended to be limiting.

As shown in FIG. 5, the example computing device 500 includes a processor 507 for executing software routines. Although a single processor is shown for the sake of clarity, the computing device 500 may also include a multi-processor system. The processor 507 is connected to a communication infrastructure 506 for communication with other components of the computing device 500. The communication infrastructure 506 may include, for example, a communications bus, cross-bar, or network.

The computing device 500 further includes a main memory 508, such as a random access memory (RAM), and a secondary memory 510. The secondary memory 510 may include, for example, a storage drive 512, which may be a hard disk drive, a solid state drive or a hybrid drive and/or a removable storage drive 517, which may include a magnetic tape drive, an optical disk drive, a solid state storage drive (such as a USB flash drive, a flash memory device, a solid state drive or a memory card), or the like. The removable storage drive 517 reads from and/or writes to a removable storage medium 577 in a well-known manner. The removable storage medium 577 may include magnetic tape, optical disk, non-volatile memory storage medium, or the like, which is read by and written to by removable storage drive 517. As will be appreciated by persons skilled in the relevant art(s), the removable storage medium 577 includes a computer readable storage medium having stored therein computer executable program code instructions and/or data.

In an alternative implementation, the secondary memory 510 may additionally or alternatively include other similar means for allowing computer programs or other instructions to be loaded into the computing device 500. Such means can include, for example, a removable storage unit 522 and an interface 550. Examples of a removable storage unit 522 and interface 550 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 522 and interfaces 550 which allow software and data to be transferred from the removable storage unit 522 to the computer system 500.

The computing device 500 also includes at least one communication interface 527. The communication interface 527 allows software and data to be transferred between computing device 500 and external devices via a communication path 526. In various embodiments of the inventions, the communication interface 527 permits data to be transferred between the computing device 500 and a data communication network, such as a public data or private data communication network. The communication interface 527 may be used to exchange data between different computing devices 500 which such computing devices 500 form part an interconnected computer network. Examples of a communication interface 527 can include a modem, a network interface (such as an Ethernet card), a communication port (such as a serial, parallel, printer, GPIB, IEEE 1394, RJ45, USB), an antenna with associated circuitry and the like. The communication interface 527 may be wired or may be wireless. Software and data transferred via the communication interface 527 are in the form of signals which can be electronic, electromagnetic, optical or other signals capable of being received by communication interface 527. These signals are provided to the communication interface via the communication path 526.

As shown in FIG. 5, the computing device 500 further includes a display interface 502 which performs operations for rendering images to an associated display 550 and an audio interface 552 for performing operations for playing audio content via associated speaker(s) 557.

As used herein, the term “computer program product” may refer, in part, to removable storage medium 577, removable storage unit 522, a hard disk installed in storage drive 512, or a carrier wave carrying software over communication path 526 (wireless link or cable) to communication interface 527. Computer readable storage media refers to any non-transitory, non-volatile tangible storage medium that provides recorded instructions and/or data to the computing device 500 for execution and/or processing. Examples of such storage media include magnetic tape, CD-ROM, DVD, Blu-ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a PCMCIA card and the like, whether or not such devices are internal or external of the computing device 500. Examples of transitory or non-tangible computer readable transmission media that may also participate in the provision of software, application programs, instructions and/or data to the computing device 500 include radio or infra-red transmission channels as well as a network connection to another computer or networked device, and the Internet or Intranets including e-mail transmissions and information recorded on Websites and the like.

The computer programs (also called computer program code) are stored in main memory 508 and/or secondary memory 510. Computer programs can also be received via the communication interface 527. Such computer programs, when executed, enable the computing device 500 to perform one or more features of embodiments discussed herein. In various embodiments, the computer programs, when executed, enable the processor 507 to perform features of the above-described embodiments. Accordingly, such computer programs represent controllers of the computer system 500.

Software may be stored in a computer program product and loaded into the computing device 500 using the removable storage drive 517, the storage drive 512, or the interface 550. The computer program product may be a non-transitory computer readable medium. Alternatively, the computer program product may be downloaded to the computer system 500 over the communication path 526. The software, when executed by the processor 507, causes the computing device 500 to perform the necessary operations to execute the method 400 as shown in FIG. 4.

It is to be understood that the embodiment of FIG. 5 is presented merely by way of example to explain the operation and structure of the system 500. Therefore, in some embodiments one or more features of the computing device 500 may be omitted. Also, in some embodiments, one or more features of the computing device 500 may be combined together. Additionally, in some embodiments, one or more features of the computing device 500 may be split into one or more component parts.

It will be appreciated that the elements illustrated in FIG. 5 function to provide means for performing the various functions and operations of the system as described in the above embodiments.

When the computing device 500 is configured to realise the system 100 to process one or more natural language video analytics commands, the system 100 will have a non-transitory computer readable medium having stored thereon an application which when executed causes the system 100 to perform steps comprising: (i) receiving, by a processing device, an identifier and tracking information associated with each detected object within an overlapping portion of a first video stream from a first camera and a second video stream from a second camera, the overlapping portion associated with partially overlapping fields of view of the first and second cameras, (ii) determining, using the processing device, positional information of each detected object relative to a common coordinate system using the tracking information and a homography matrix associated with the partially overlapping fields of view of the first and second cameras, (iii) matching, using the processing device, one detected object in the first video stream with another detected object in the second video stream, the matching based on a criterion of minimum distance between the detected objects, using the positional information of each detected object, (iv) associating, using the processing device, the identifiers of the matched objects, and (v) recording, using the processing device, the associated identifiers in a correspondence table for object tracking analysis.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A multi-camera object tracking system, the system comprising:
at least one processor; and
at least one memory including computer program code;
wherein the at least one processor, at least one memory and the computer program code are configured to allow the system to:
receive an identifier and tracking information associated with each detected object within an overlapping portion of a first video stream from a first camera and a second video stream from a second camera, the overlapping portion associated with partially overlapping fields of view of the first and second cameras;
determine positional information of each detected object relative to a common coordinate system using the tracking information and a homography matrix associated with the partially overlapping fields of view of the first and second cameras;
match one detected object in the first video stream with another detected object in the second video stream, based on a criterion of minimum distance between the detected objects, using the positional information of each detected object;
associate the identifiers of the matched objects; and
record the associated identifiers in a correspondence table for object tracking analysis.

2. The system as claimed in claim 1, wherein, to receive the identifier and tracking information associated with each detected object within the overlapping portion of the first video stream from the first camera and the second video stream from the second camera, the system is configured to:
receive the first video stream from the first camera and the second video stream from the second camera;
detect objects in the first and the second video streams within the overlapping portion of the first and the second video streams;
determine tracking information associated with each detected object; and
record the identifier and the tracking information associated with each detected object.

3. The system as claimed in claim 2, wherein the tracking information comprises a detection box and wherein, to determine the tracking information associated with each detected object, the system is configured to:
map an element of the detection box of each detected object within the overlapping portion in the first and second video streams to the common coordinate system using the homography matrix associated with the partially overlapping fields of view of the first and second cameras.

4. The system as claimed in claim 3, wherein, to match the one detected object in the first video stream with the another detected object in the second video stream based on the minimum distance therebetween using the positional information of each detected object, the system is configured to:
calculate, for each detected object in the first video stream, a distance between the element and a corresponding element of a detected object in the second video stream;
determine a pair comprising an element in the first video stream and a corresponding element in the second video stream with a minimum distance therebetween; and
match the detected object in the first video stream associated with the element with the detected object in the second video stream associated with the corresponding element.

5. The system as claimed in claim 1, wherein the system is further configured to:
associate the matched objects with a unique global identifier; and
record the global identifier in the correspondence table for object tracking analysis.

6. The system as claimed in claim 5, wherein, to associate the matched objects with the unique global identifier, the system is configured to:
determine if any of the identifiers of the matched objects correspond to an existing global identifier; and
in response to a positive determination that at least one of the identifiers of the matched objects correspond to an existing unique identifier, verify that the matched objects in the first and second video stream associated with the existing global identifier meet the criterion of minimum distance between the detected objects using the positional information of each detected object.

7. The system as claimed in claim 6, wherein the system is further configured to:
in response to a positive determination that the matched objects in the first and second video stream do not meet the criterion of minimum distance, re-match one detected object in the first video stream with another detected object in the second video stream based on the criterion of minimum distance between the detected objects, using the positional information of each detected object;
associate the identifiers of the matched objects; and
update the global identifier in the correspondence table for object tracking analysis.

8. A method of operating a multi-camera object tracking system, the method comprising:
receiving, by a processing device, an identifier and tracking information associated with each detected object within an overlapping portion of a first video stream from a first camera and a second video stream from a second camera, the overlapping portion associated with partially overlapping fields of view of the first and second cameras;
determining, using the processing device, positional information of each detected object relative to a common coordinate system using the tracking information and a homography matrix associated with the partially overlapping fields of view of the first and second cameras;
matching, using the processing device, one detected object in the first video stream with another detected object in the second video stream, the matching based on a criterion of minimum distance between the detected objects, using the positional information of each detected object;
associating, using the processing device, the identifiers of the matched objects; and
recording, using the processing device, the associated identifiers in a correspondence table for object tracking analysis.

9. The method as claimed in claim 8, wherein the step of receiving the identifier and the tracking information associated with each detected object within the overlapping portion comprises:
receiving, by the processing device, the first video stream from the first camera and the second video stream from the second camera;
detecting, using the processing device, objects in the first and the second video streams within the overlapping portion of the first and the second video streams;
determining, using the processing device, tracking information associated with each detected object; and
recording, using the processing device, the identifier and the tracking information associated with each detected object.

10. The method as claimed in claim 9, wherein the tracking information comprises a detection box and the step of determining the tracking information associated with each detected object comprises:
mapping, using the processing device, an element of the detection box of each detected object within the overlapping portion in the first and second video streams to the common coordinate system using the homography matrix associated with the partially overlapping fields of view of the first and second cameras.

11. The method as claimed in claim 10, wherein the step of matching the one detected object in the first video stream with the another detected object in the second video stream based on the minimum distance therebetween using the positional information of each detected object comprises:
calculating, for each detected object in the first video stream, a distance between the element and a corresponding element of a detected object in the second video stream using the processing device;
determining, using the processing device, a pair comprising an element in the first video stream and a corresponding element in the second video stream with a minimum distance therebetween; and
matching the detected object in the first video stream associated with the element with the detected object in the second video stream associated with the corresponding element.

12. The method as claimed in claim 8, further comprising the steps of:
associating, using the processing device, the matched objects with a unique global identifier; and
recording, using the processing device, the global identifier in the correspondence table for object tracking analysis.

13. The method as claimed in claim 12, wherein the step of associating the matched objects with the unique global identifier comprises:
determining, using the processing device, if any of the identifiers of the matched objects correspond to an existing global identifier; and
in response to a positive determination that at least one of the identifiers of the matched objects correspond to an existing unique identifier, verifying, using the processing device, that the matched objects in the first and second video stream associated with the existing global identifier meet the criterion of minimum distance between the detected objects using the positional information of each detected object.

14. The method as claimed in claim 13, wherein the method further comprises:
in response to a positive determination that the matched objects in the first and second video stream do not meet the criterion of minimum distance, re-matching, using the processing device, one detected object in the first video stream with another detected object in the second video stream based on the criterion of minimum distance between the detected objects, using the positional information of each detected object;
associating, using the processing device, the identifiers of the matched objects; and
updating, using the processing device, the global identifier in the correspondence table for object tracking analysis.
